(19) United States
(12) Patent Application Publication
(10) Pub. No.: US 2009/0094517 A1
(43) Pub. Date: Apr. 9, 2009

(54) Conversational advertising

(76) Inventors: Jonathan S. Brody, Taipei (TW); Victor Wong, Newmarket (CA)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/986,914

(22) Filed: Nov. 27, 2007

Related U.S. Application Data
(60) Provisional application No. 60/997,505, filed on Oct. 3, 2007.

(51) Int. Cl. G06F 3/048

(52) U.S. Cl. 715/706

(57) ABSTRACT

A method of advertising in a computer medium, such as the Internet. The method includes providing a virtual instructor in a virtual environment. The virtual instructor is configured to provide content, such as, a foreign language instruction or a translation service of existing foreign language web pages to a user over the Internet. In the substantive content, the virtual instructor embeds or hides promotional content in the substantive content. This promotional content can be a spoken advertisement to the user. The promotional content can be introduced in a subtle manner, and does not distract the user from the lesson. The advertisement may be spoken to the user by the virtual instructor at the time the educational content is provided to the user.

### CROSS REFERENCE TO RELATED PATENT APPLICATIONS

This patent application claims priority to U.S. Provisional Patent Application Ser. No. 60/997,505 filed on Oct. 3, 2007. The entire teachings of the above patent application are incorporated by reference.

### BACKGROUND OF THE INVENTION

Advertising displayed in Internet content is known in the art. United States Published Patent Application No. US 2007/0134640 A1 to Masaoka (hereinafter “Masaoka”) discloses a system for learning a foreign language in an interactive manner.

The system is directed to using promotional information as course material to serve both an educational purpose, and also to serve a promotional purpose. The system provides language lessons, such as English lessons, at no cost to consumers with ads for products or services embedded or hidden as a product placement shown (in the foreground and background) in the English lessons. Masaoka also discloses gathering marketing information about the user's reaction to the product or the services. The user can register and participate in the lessons that take the form of a quiz with multiple choice answers.

A problem with the Masaoka system is that the product placement is not subtle where the product placement or descriptions of the advertisement are displayed as answers to multiple choice quiz questions that the user has to select. Further, the system also requires that the users would have to intermittently watch a short video advertisement which may interrupt the text-based foreign language lesson. This change in the media format may distract the user.

### SUMMARY OF THE INVENTION

The present invention is directed to a method of advertising in a computer medium using a simulated conversation in a virtual environment between a virtual object and the user. The virtual object provides content to a user in a simulated conversation between the virtual object and the user. In the simulated conversation, the virtual object can speak about product or service details (aspects) in terms of the user's expressed likes and dislikes or other comments made by the user, In this way, the virtual object makes conversation that effectively, but subtly, speaks an advertisement to the user (hereinafter referred to as conversational advertising or a conversational advertisement).

The virtual object can be a two or three dimensional avatar, and the virtual environment can be a virtual storefront. The virtual storefront may be selected by the advertiser.

The content of the simulated conversation can be educational in nature. The content may take the form of an instruction to the user, such as, for example, a foreign language instruction. During the speech, where the virtual object provides the foreign language instructions, the advertisement can be spoken in a subtle manner to the user.

The advertisement is not only limited to conversational advertisements, and additionally can be provided in other forms. For example, the advertisements can be provided as an image associated with the virtual object, an image associated with the virtual environment, or can be provided in other ways. Preferably, the advertisement is embedded or hidden inside the foreign language instruction. The advertisement is also provided in an intermittent manner. This is perceived to be subtle since the content is provided continuously, and the advertisement spoken in a manner that is not distracting and is spaced over time.

The advertisement can be promotional in nature, and may describe an advertiser's product or service in the educational lesson. The advertisement may also provide substantive information to the user about the products or services. The advertisements can also simply provide the user with the look and feel of the promoter's storefront.

A hyperlink may be displayed with the foreign language instruction. The hyperlink may link the webpage to a second e-commerce webpage so the user can purchase the product or service that the user is learning about.

The virtual object may further assist the user or emulate speech directed to the user to ensure the user's purchase of a desired product or service.

The virtual object is mobile, and can move through a number of different virtual environments as the user browses the Internet or navigates to a different virtual environment.

The virtual object can be a virtual foreign language instructor, and the user's speech can be recorded, and the foreign language instructor can provide additional content based on the user's recorded speech based on program instructions stored in a memory.

In yet another embodiment, the avatar, or two dimensional or three dimensional foreign language instructor, may assist with translating an existing webpage remote from the previously described virtual environment. The avatar may translate an existing webpage in a foreign language to a native language or a language known by the user. During the translating, the avatar may further provide an advertisement, or promotion, or gently persuade the user to make a purchase. The avatar may simply provide information to the user to peak the user's interest in a product or service. Additional sponsored links may further be provided on the displayed screen overlaying the virtual environment. These sponsored links may be paid for by the same or a different advertiser. Additionally, certain attractive objects may be placed in the virtual environment that may provide a suggestion for a purchase. The avatar may also describe those objects to the user to peak the user's interest. The objects may also include an icon that links to a site for purchase.

During browsing of several different Internet web pages, the avatar can overlay either an Internet browsing application or the webpage to provide a foreign language translation or for another educational purpose. During the emulated conversation between the virtual object, and the user, traditional advertisements (popup ad, banner ad, hyperlink, or other) can be provided for the user.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic view illustrating user communicating over a global network with a server to receive a foreign language instruction in a virtual storefront;

FIG. 1B is a schematic view illustrating a foreign language instruction in a virtual storefront;

FIG. 2 shows the virtual instructor providing a foreign language instruction.

FIG. 3 shows the virtual instructor translating a foreign language bearing website while providing conversational advertisements.

FIG. 4 is a flow diagram of one embodiment of the present invention.

### DETAILED DESCRIPTION OF THE INVENTION

A description of example embodiments of the invention follows.

The present disclosure is directed to conversational advertising, or a process by which an immersive multimedia simulation is built around products or services of an advertising sponsor. In one aspect, a virtual object can be provided in a virtual environment, and the user by opening a web page, or by running a computer program product or other computer related application can simulate conversation with the virtual object. Preferably the virtual object 12 includes computer code to emulate speech with the user and may emulate speaking to the user or emulate responding to the user. This can be from a number of programmed responses stored in a memory. This conversation may be either forked or linear, but in either instance, however, the virtual object 12 may engage in subtle advertising messages. These messages are embedded into the emulated speech as conversation. These subtle messages preferably may be spaced apart during the course of the emulated speech. These subtle messages may revolve around an advertising sponsor's products, marketing messages, broadening product promotion, or any other branding or advertising known in the art. This is not limited to a single sponsor, or advertiser, and it is envisioned that multiple advertising sponsors can be used at the same time.

In one aspect, the conversational advertisement preferably provides a high value revenue stream to support an interactive website. The present invention may be provided together with a stand alone website, a sponsor's own website, an infomercial, or a marketing promotion. The present invention may be associated with a computer program product or can be available on an Internet search engine, an Internet portal, stand alone Internet website, an FTP site, an e-commerce Internet site, or located in a memory associated with a computer that is at any kiosk, shopping mall, hospital, information terminal, or educational institution. The software application can be provided free of charge, or the software application can be provided for a pay per use charge, or a bulk licensing arrangement, in any public or private area.

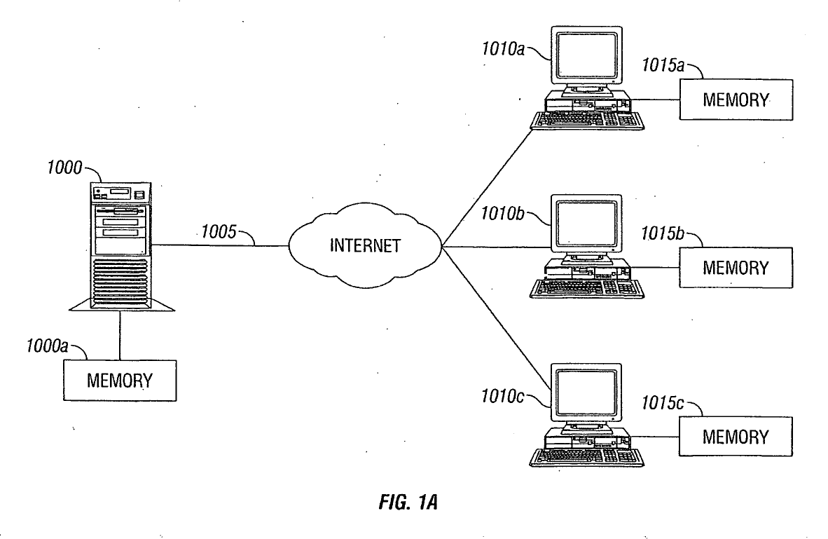

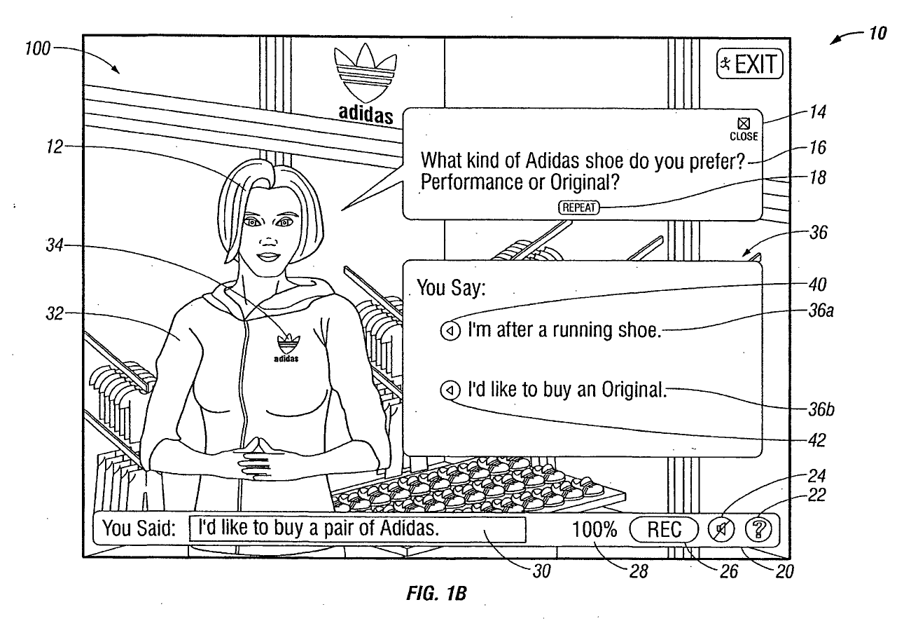

FIG. 1A shows one embodiment, where a server or network computer 1000 having a memory 1000a communicates with a number of user computers 1010a, 1010b, 1010c, etc. over a global computing network (e.g., the Internet) along line 1005 however, this arrangement is not limiting and the present invention may be delivered or stored on the user or the server side, or on a recordable medium for use in a stand alone site. Alternatively, the computer implemented language instruction may be delivered in a wireless format along line 1005 to a Smartphone or a mobile cell phone, or other mobile device.

Turning now to FIG. 1B, there is shown a screen shot of a webpage that a user will open using a conventional global computer network (e.g., Internet) browser such as MICROSOFT™ INTERNET EXPLORER™, MICROSOFT™ WINDOWS MOBILE INTERNET EXPLORER™, OPERA™, MOZILLA™, APPLE™ OSX™, SYMBIAN™, or any other Navigation Internet browsing application known in the art. It should be appreciated that such an Internet browsing application to run such a computer program is well known in the art, and various programming languages and software applications can be used and are within the scope of the present disclosure. The present disclosure is described in the context of a webpage, but the method is not limited to any such Internet based application. Various other computer implementations can be used and are within the scope of the present disclosure. Preferably the application is downloaded over a high speed Internet connection from a website to a personal computer in a home or office. In yet another embodiment, the application 10 may be located on a media, such as a CD-ROM, removable media, or hard disk, and the software can be purchased then installed on the memory and then subsequently run as a computer program product.

Preferably the webpage 10 may be displayed with a number of discrete elements, and it should be appreciated that the number of elements only show one embodiment of the present disclosure, and the software application 10 is not limited to the present elements or their shown location. It should be appreciated that the elements may have different locations. Elements may be created by an object oriented programming language, or can be written in any number of other existing programming languages, such as JAVA, LINUX, or any other programming language.

Preferably the software application 10, when executed, or otherwise displayed includes a virtual object 12, a sponsor content text box 14, an instructor question 16, a repeat instruction icon 18, and a user tool bar 20. It should be appreciated that other stylistic formats can be used, and the present application 10 is not limited to these icons and stylistic format, and may be presented in a different format.

The user tool bar 20 is located at a bottom of the webpage 10, and includes user functions such as a user speech record icon 26, a meter icon 28, and a display box 30. The user tool bar 20 may also include a help icon 22, and a mute icon 24.

Between the sponsor content text box 14 and the user tool bar 20 is a user selectable branching tool 36. The user selectable branching tool 36 includes hyperlink text that the user may select with a first selectable choice reply 36a, and a second selectable choice reply 36b. The user can also select icons 40, 42 to hear prerecorded speech audio files, and to hear the virtual object 12 emulate the speech of the choice replies 36a, 36b.

The virtual object 12 is shown as a human-like shaped two dimensional female instructor, and also includes a female head and torso with clothes 32 and a logo 34 that is predominately displayed on the virtual object 12. The virtual object 12 may also be rendered as a human-like shaped three dimensional female instructor, and is not limited to any specific configuration. The virtual object 12 is shown as being partially blocked by the tool bar 20. However, a full length virtual object 12 is also envisioned, and the inventive application 10 is not limited to the specific shown configuration, and the avatar 12 may comprise only a face, etc.

Continuing with FIG. 1B, one embodiment of the present inventive software application 10 is directed to an education application. However, the present invention application 10 is not limited to the educational application, and can be a commercial application, a recreational/entertainment application, an e-commerce application, an application to translate foreign language web documents, a social networking application or any other variety computer implemented or Internet based applications. Preferably the application 10 provides educational benefits to the user or provides foreign language instruction to a user. In the application 10, sentences may be communicated to the user in a native language with text, and then the user is to speak and record repeating each sentence back in the foreign language. The application 10 includes software components to receive the foreign language (user input) audio, convert that audio to data, compare that data to a reference file, and evaluate the quality of the spoken language. The application 10 may then output any combination of video, text, or audio to provide constructive criticism to the user and/or ask the user to recommunicate the foreign language sentence or to provide a correction. For a given sentence, once the application verifies that the user has correctly spoken the sentence, the next different sentence may be communicated to the user to provide educational benefits and to provide learning to the user.

The present software application is not limited to this configuration for foreign language instruction, and may be configured as a tutorial, school education, occupational education, distance learning, or any other tutorial.

Preferably the training is given by a virtual object 12. The virtual object 12, in one embodiment, is a human instructor in the shape of an avatar 12. It should be appreciated that the virtual object 12 is not limited to such a human character, and may be any two or three dimensional shape known in the art, such as a cartoon, character, animal, object or mythical creature. In this manner, the virtual object 12 is arbitrary, but preferably emulates communication with the user in order to simulate training the user in a pleasing manner.

The emulated communication with the user may take several forms and the present invention is not limited to any specific educational format, or hierarchal arrangement. This lesson includes audio output to the user, and to the user's computer's user's speakers, or text that is displayed to the user. However, other non-verbal signals are also envisioned. The virtual avatar instructor 12 may provide non-verbal cues, instructions, or actions, as well as verbal instructions. These may include movement of the eyes, pointing, head shaking, nodding, and following the cursor, etc.

Preferably the avatar 12 provides instructions, and embeds advertisements subtly in the communication. One example is shown in FIG. 1B. The avatar 12 may provide instructions for foreign language instruction, and within these instructions may recite advertising statements, or recite statements describing the advertiser's products as the foreign language instruction (lesson).

For example, the application 10 may provide text and output audio associated with “WHAT KIND OF ADIDAS® SHOE DO YOU PREFER? PERFORMANCE OR ORIGINAL?” The audio version may be output from a speaker and the corresponding text may displayed in a sponsor content text box 14 adjacent to the avatar 12. Then, the avatar 12 may repeat the same phrase in a different language that is desired to be learned by the user such as in Japanese, or German. The avatar 12 may then prompt the user to repeat the sentence in the foreign language, or to recite a reply. The program may then capture and record the user's speech using a microphone, evaluate the speech, and provide criticism. Text corresponding to the user's reply can be displayed in the text display box 30 shown under the avatar 12.

Advantageously, the description of the advertiser's product is spoken, and repeated as a part of the lesson. This description is displayed so the user can subtly learn about the product and so the user can formulate an interest in the product. This is advantageous as no demand for the user to purchase is made, and by repeating and by reading the user can subtly associate images of the product with names or features of the products. For example, a specific shoe name, price of the shoe, shoe color, branding, information about which celebrities wear the shoe, etc. all may be provided in conversation without asking that the user make a purchase to promote the desired item. In one embodiment, the avatar 12 may make advertising statements similar to a virtual salesperson.

The software application 10 may include a tool bar 20 operable to receive an audio signal from a microphone associated with the individual's computer and display text corresponding to the user's speech in the text display box 30. The audio signal may be recorded by selecting the record icon 26 on user tool bar 20. The audio signal may be converted to a digital signal to be evaluated by a speech recognition software application, such as, for example NUANCE® Speech Translation Software of Burlington, Mass. or any other speech translation known in the art.

In response to the received digital signal, the software application 10 may prompt the user to repeat the phrase in the foreign language, correct the user, or move on to the next phrase that may further include a second spoken advertisement or substantive information about the sponsor's product. Alternatively, the advertisements can be spaced apart from the continuous educational content at predetermined intervals so as not to detract from the educational lesson.

In the embodiment of FIG. 1B, the avatar 12 may accommodate different sayings that are in a foreign language, and that are selected by the user, such as, a first choice 36a icon, and a second choice icon 36b in the user selectable branching tool 36.

The avatar 12 is preferably disposed in a simulated or virtual environment 100. The virtual environment 100 can be any scene or location including images associated with famous or picturesque locations, but preferably the virtual environment 100 is also promotional content that is associated with the sponsor. Preferably the virtual environment 100 is complementary to the sponsor's advertisement, and is associated with the sponsor's products, or alternatively provides educational information to the user pertaining to the look and feel of the advertiser's products, and storefront.

In the embodiment shown in FIG. 1B, the avatar 12 is a female two or three dimensional-looking character named “LUCY,” and the virtual environment 100 is an ADIDAS® virtual storefront that sell shoes, clothes, and footwear. For example, a different coffeehouse virtual environment may include images associated with look and feel of the coffeehouse and the different brands of coffee, coffee cup sizes, music and other products offered. For a virtual environment 100 being a restaurant, the virtual environment 100 may show images associated with the food service counter, waitress, food, food preparation, and the dining room, etc.

The virtual environment 100 may also be permitted to selectively change at predetermined intervals depending on either a selection made by the user, or by a promotional decision made by an advertiser programmed into the application 10. For example, the advertiser may wish to display various different views of the storefront 100, and the virtual environment 100 may display one image, then periodically change to a second different image in the same virtual storefront 100. This may further promote the advertiser's products or educate the user with the advertiser's products.

In another embodiment, the virtual environment 100 may switch locations between the footwear section to an apparel section, or to a cashier in the same virtual environment 100, etc. Further, this movement may be controlled by the user, and the user may desire to move out of one virtual storefront, and into a second different virtual storefront with the avatar 12, such as in a virtual mall. In yet another embodiment, the user may record specific speech commands to instruct the avatar 12 to change the virtual environment 100 as a part of the lesson.

Preferably, the avatar 12 includes a virtual image associated with a uniform 32. The uniform 32 includes images that are further associated with the promotion or advertisements. As shown, the avatar 12 may appear to wear an ADIDAS® long sleeve shirt image 32 with an ADIDAS® logo 34. Other branding combinations are possible, and the virtual object 12 may be the actual logo, and the logo can appear to emulate language instruction, or the avatar 12 may have a tattoo associated with the promoter or sponsor's logo, etc.

In yet a further embodiment, the software application 10 preferably attempts to move the user to make a sale in real time by either clicking on a hyperlink (not shown) or by consummating a transaction with the avatar 12 using speech commands. In this aspect, the hyperlink (not shown) may simply point the user's browser to a specific e-commerce page once a user desires to buy an item that the user is learning about from the avatar 12 or lesson. Alternatively, the avatar 12 may receive voice commands from the user recorded using speech record icon 26. These voice commands can include an instruction to purchase the desired item by the user. Furthermore, the avatar 12 may also prompt the user to provide and record speech that includes payment information, shipping information, or other information to complete the purchase of the desired items. In yet a further embodiment, the avatar 12 may display a hyperlink (e.g., “BUY ITEM”) in the user selectable branching tool 36″ for the user to select and purchase services or goods that are being discussed, or subtly introduced in the lesson/communication. Preferably subtly introduced can mean that the avatar 12 waits for a period of time before mentioning persuading the user to purchase. This can be as subtle as asking would you like to buy the item.

In yet another embodiment, the avatar 12 may ask questions to the user about certain new products to obtain marketing and consumer testing information. This marketing and consumer testing information may be collected for use later on. The avatar 12 may display an image associated with a specific product where marketing information is desired along with a foreign language instruction. The image may be associated with a new product such as a new model of sneakers, or new jersey, or new shirt in a specific new fashion scheme or new color. The avatar 12 may provide the foreign language instruction, and during the instruction together with the lesson may then ask the user to provide comments in a query 16 directed to the new product in the foreign language as part of the instruction (in the sponsored content text box 14). The comments may be positive or negative, and as simple as does the consumer like the product, and what does the consumer like, and dislike. This data may be recorded over time in order to provide feedback to the sponsor or marketing company or a marketing department. The application 10 may further collect demographic information about the user, either provided as user input at an initialization procedure, or from cookies associated with the user's browser. Preferably, the virtual object 10 and the virtual environment 100 may include immersive multimedia elements so as to appear consistent with an interactive tutorial.

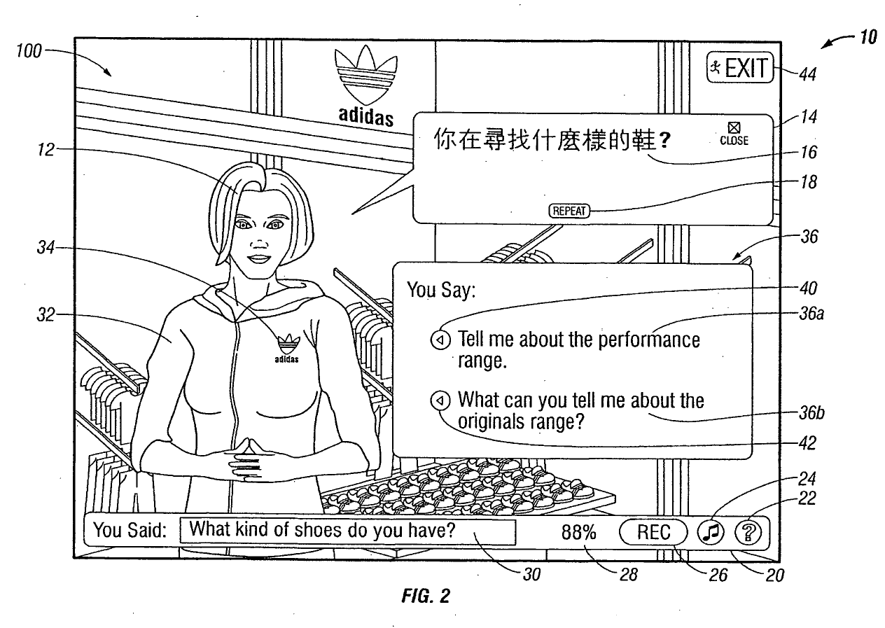

Turning now to FIG. 2, there is shown the avatar 12 with animated expressions and movements providing the translated text 16 in the sponsored content text box 14. The sponsored content text box 14 may be dynamic and the user can switch from between the two languages for reference purposes. Additionally, the user can select “repeat instruction” icon 18 to repeat the translated text for as many times as required for optimal education utility.

Preferably, at the conclusion of the foreign language sentence or statement, the avatar 12 guides the user to the next conversation or sentence to further instruct. Preferably the advertisement is embedded or hidden in speech, and embeds the promotion in the instruction at long intervals between substantially continuous educating phrases. The advertisements are preferably subtle and are spoken, and do not distract from the language instruction. For example, the next three sentences in the lesson may have no advertisement. The user may exit the session by clicking on exit icon 44, and in this manner, the avatar 12 may terminate instruction, or follow the user as an overlay to another web page. The existing web page may include social networking sites, portals, a chat room, etc.

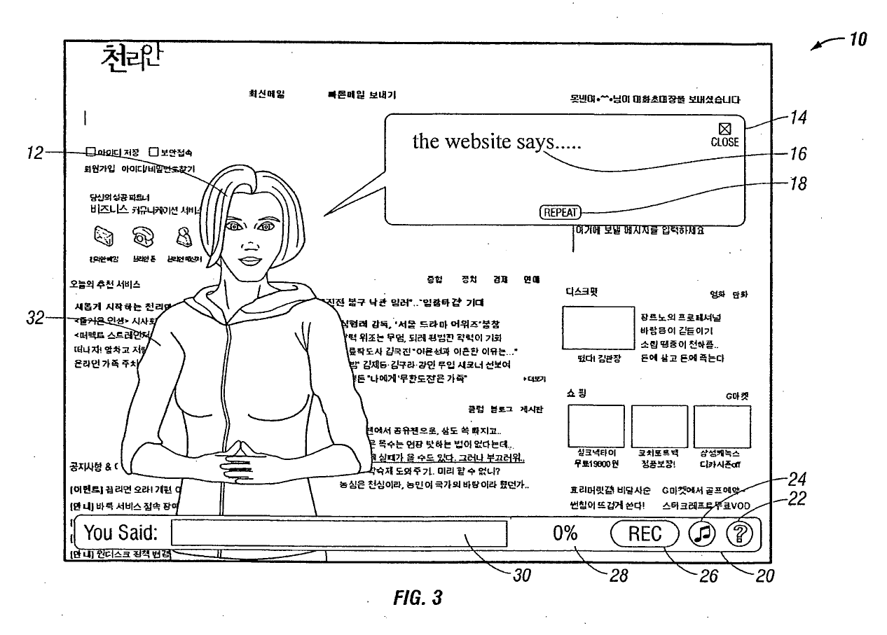

The avatar 12 may be latent or assertive, and may, for example, be prompted to guide the user to open up a bank account with a specific bank or take an insurance policy while learning a language. Turning now to FIG. 3, the avatar 12 may further be configured to act as a universal translator of web pages rendered in a foreign language. For example, an English speaking user may surf Internet pages in a different language, such as in Chinese or Korean. Alternatively, a non-English speaking native Chinese Internet user may surf to a specific domain that is in a further foreign language. Both surfers when encountering foreign language Internet WebPages are unable to read and understand the content.

Using the avatar 12 that overlays the foreign webpage, either user may learn a desired language by reading the foreign language webpage with the assistance of the virtual object 12. In particular, the object 12 assists with translating the foreign language webpage displayed in the background (shown in FIG. 3) into the native language for the user in a sentence by sentence manner. This is advantageous, particularly, because a user would have access to so many newly translated websites that were previously unavailable. The application 10 preferably includes several look-up foreign language reference tables for the application 10 to reference, and the user may browse from French pages to Chinese pages to any foreign language page on the web. Moreover, during the translation of the foreign language webpage, the avatar 12 may embed conversational advertisements, or other ads and promotional statements in the translated content.

The avatar 12 preferably overlays the foreign webpage or Internet browsing application, and may traverse with the user to different websites that are rendered in a foreign language. The user can learn a desired language by reading the foreign language webpage with the assistance of the virtual object 12 which translates each foreign language webpage displayed in the background shown in FIG. 3. The avatar 12 may detect that certain websites are in the native language of the user, and the inventive application 10 is minimized, and then the application 10 maximizes when a foreign language bearing website is detected.

In yet another embodiment, the virtual object 12 may tutor multiple users at the same time. The virtual environment 100 may be accessible to plural users. The present application is not limited to one user, and plural users can be located in the virtual environment 100 of FIG. 2. In this embodiment, the multiple users may engage selectively with the avatar 12 for foreign language instructions. Moreover, all users can interact with one another, and the multiple users may be permitted to instant message, e-mail, or chat among themselves thereby practicing the lesson (assignment) taught by the foreign language instructing avatar 12. The present software application 10 is also not limited to one avatar 12, and multiple avatars 12 for multiple users, multiple product lines, specialties, different languages are also envisioned.

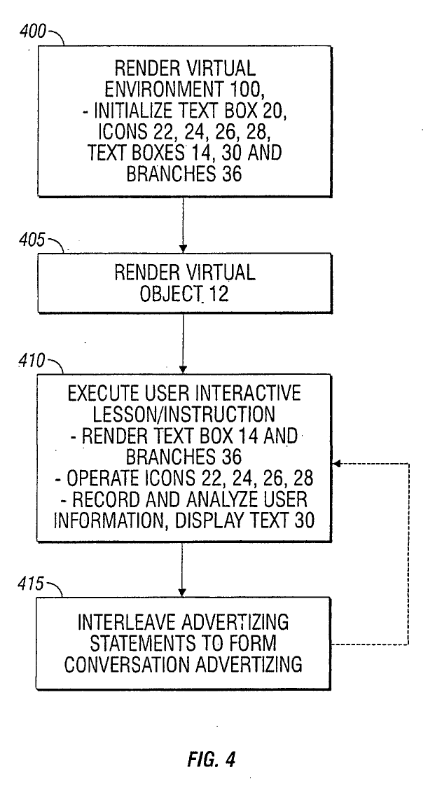

Turning now to FIG. 4, there is shown a flow diagram of computer implemented method 400. At step 405, the virtual environment is rendered. At step 410, the virtual object is rendered. At step 415, the user interacts with the object 12 to receive the lesson, and preferably the text box 14 and branching 35 with icons 22, 24, 26, and 28 are rendered. Preferably, the user's speech is recorded and analyzed, and can be displayed in text box icon 30. At step 420 preferably, conversational advertisements are interleaved into the content, and preferably, the conversational advertisements can be continuously further subtly provided in the lesson at step 415.

Preferably the educational data can be performed free of charge, or for a fee. In yet another embodiment, the avatar 12 may be supplemented with a real-life instructor for a fee. The education may be further configured so a professional real life educator may also be accessible, when the user so desires by selecting an icon (not shown).

While this invention has been particularly shown and described with references to example embodiments thereof, it will be understood by those skilled in the art that various changes in form and details may be made therein without departing from the scope of the invention encompassed by the appended claims.

What is claimed is:

1. A method of advertising in a computer medium comprising:
providing a virtual object in a virtual environment, the virtual object being configured to provide content to a user; and
providing an advertisement in the content to the user.

2. The method of claim 1, wherein the virtual object is a two or three dimensional avatar.

3. The method of claim 1, wherein the virtual environment is a virtual storefront selected by an advertiser.

4. The method of claim 1, wherein the content is educational.

5. The method of claim 4, wherein the content is an instruction to a user.

6. The method of claim 5, wherein the content is a foreign language instruction.

7. The method of claim 1, wherein the advertisement is provided as simulated speech by the virtual object.

8. The method of claim 7, wherein the advertisement is further provided as an image associated with the virtual object.

9. The method of claim 7, wherein the advertisement is further provided as an image associated with the virtual environment.

10. The method of claim 1, wherein the virtual object emulates speech to the user in a foreign language training instruction, and wherein the advertisement is a description of a item or good desired to be sold that is described in the foreign language training instruction.

11. The method of claim 10, wherein the advertisement is embedded into the foreign language training instruction, and wherein the advertisement is provided in an intermittent manner relative to the content, which is provided substantially continuously.

12. The method of claim 11, wherein the advertisement is promotional, and describes an advertiser's product or service in the foreign language instruction.

13. The method of claim 10, wherein the advertisement further provides substantive descriptive information to the user about the advertiser's product or service.

14. The method of claim 1, further comprising providing a hyperlink to an interactive website to purchase a product or service.

15. The method of claim 1, wherein the virtual object assists the user with a purchase of a product or a service.

16. The method of claim 1, wherein the virtual object can traverse through a plurality of virtual environments.

17. The method of claim 2, wherein the two or three-dimensional avatar is a virtual instructor.

18. The method of claim 1, further comprising receiving and recording speech from the user, and providing content based on the recorded speech.

19. The method of claim 18, wherein the content is a foreign language instruction, and wherein the received speech is the user practicing repeating the foreign language instruction.

20. A system for promoting products or services comprising:
a virtual object;
a virtual environment;
the virtual object being located in the virtual environment and providing content to a user; and
a promotion being embedded in the content.

21. A computer recordable medium comprising:
program instructions for providing a virtual object in a virtual environment, the virtual object providing content to the user; and
program instruction for providing an advertisement or a promotion to a user, the advertisement or promotion being embedded in the provided content.

22. The system of claim 20, wherein the content is educational.

23. The method of claim 1, wherein the content is associated with a translation of a foreign web page.

24. A method of translating a web page comprising:
providing a virtual object overlying an existing webpage;
providing a translation of the existing webpage in a foreign language to a user by the virtual object emulating speech of the translation to a native language; and
providing an advertisement or promotion in the translation to the user.

25. The method of claim 24, wherein the virtual object is a two or three dimensional avatar, and further comprising an Internet browsing application for loading a second existing webpage, and wherein during browsing of Internet web pages, the avatar overlays at least one of the browser or the webpage.
